(19) United States
(12) Patent Application Publication
(10) Pub. No.: US 2025/0328724 A1
(43) Pub. Date: Oct. 23, 2025

(54) METHOD AND SYSTEM FOR INGESTING AND EXECUTING ELECTRONIC CONTENT PROVIDING PERFORMANCE DATA AND ENABLING DYNAMIC AND INTELLIGENT AUGMENTATION

(71) Applicant: AUGMENTIR, INC., Horsham, PA (US)

(72) Inventors: Russell FADEL, Pebble Beach, CA (US); Lawrence FAN, Irvine, CA (US); Phillip J. HUBER, Orange, CA (US)

(21) Appl. No.: 18/870,276

(22) PCT Filed: May 31, 2023
(86) PCT No.: PCT/US2023/067694

§ 371 Date: Nov. 27, 2024

Related U.S. Application Data
(60) Provisional application No. 63/347,429, filed on May 31, 2022.

(51) Int. Cl. G06F 40/186; G06F 3/0482; G06F 40/103

(52) U.S. Cl. CPC G06F 40/186; G06F 3/0482; G06F 40/103

(57) ABSTRACT

A method for ingesting existing content that describes a procedure of a sequence of activities without changing it and providing performance data and algorithms to the sequence of activities to improve the effectiveness of the procedure when executed is disclosed. Once documents are ingested, users can add performance linked augmentations to enhance the effectiveness of the document to increase user performance and process outcomes. Augmentations are created anywhere in the document. Each of these augmentations are controlled by a performance engine on the server which can collect data related to the performance of the procedure.

### PRIORITY CLAIM

The present disclosure claims benefit of and priority to U.S. Provisional No. 63/347,429, filed May 31, 2022. The contents of that application are hereby incorporated by reference in their entirety.

### TECHNICAL FIELD

The present disclosure generally relates to a system and method for augmenting a set of procedures and collecting data as to performance by workers of a procedure for determining the performance of each worker of the procedure.

### BACKGROUND

Determining where there is an opportunity for productivity improvement in frontline workers or processes is an issue that conventional systems have attempted to solve unsuccessfully. For example, in conventional systems, procedures are simply available in paper or static electronic media without any ability to tailor the content of such procedures so workers may implement such procedures more efficiently. Further productivity improvements were performed through time and motion studies, i.e., watching a person do his or her job for a short period of time and then analyzing this data to identify those activities, steps, etc., that need to be changed to increase productivity. Such studies were often ineffective and time consuming. Newer systems enable more interactive guidance of frontline workers but require new procedures to be written in a different format. This leaves companies with thousands of existing electronic documents that must be manually reproduced to gain the benefit of richer guidance and continuous time in motion data. There is thus a need for a system that uses existing documents to get performance data on workers and processes and add augmentations to make these documents better able to guide and support workers so that they can be more efficient while leaving the source document unchanged.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter; nor is it intended to be used in isolation to determine the scope of the claimed subject matter. The subject matter should be understood by reference to appropriate portions of the entire specification of this disclosure, any or all drawings and each claim.

One disclosed example is a method for method for creating an interactive document file. A document having a description of a sequence of activities is selected. The document is converted into an electronic file format that allows application of an augmentation. At least one augmentation is selected for the sequence of activities. The selected augmentation is applied to the converted document in the electronic file format.

In another disclosed implementation of the example method, the augmentation is one of an addition to enhance the communication of the information in the converted document, a logical element to guide users to appropriate sections of the converted document, or a data collection element to enable digital data capture. In another disclosed implementation, the augmentation is one of the group of data entry; media display; attached documents; mixed or augmented reality experiences; troubleshooting elements; remote video assistance; remote audio assistance; step name with metadata; quizzes/tests; checklists; table entry; procedure metadata; picker interfaces; bar code or QR scanner; media capture; table displays; picker tables; signature entry; jump; loops to other sections; branches to other sections; escalation; index sections; embedded procedures; biometric; image recognition; and training content. In another disclosed implementation, the method further includes selecting a plurality of converted documents that have similar characteristics to the converted document; and automatically selecting and applying the at least one augmentation to the plurality of converted documents. In another disclosed implementation, the method further includes displaying an authoring interface showing the converted document and a menu allowing selection of the at least one augmentation from a plurality of different augmentations. In another disclosed implementation, the method further includes sending the converted document with the augmentation to a user device. In another disclosed implementation, the method further includes applying a rule to determine whether the selected augmentation is activated on a display of the user device. In another disclosed implementation, the augmentation accepts input data from a worker associated with the user device, and the input data is sent to a cloud client application in communication with the user device.

Another disclosed example is a system including a memory and a controller including one or more processors. The controller is operable to select a document having a description of a sequence of activities. The controller is operable to convert the document into an electronic file format that allows application of an augmentation. The controller is operable to select at least one augmentation for the sequence of activities. The controller is operable to apply the selected augmentation to the converted document in the electronic file format.

In another disclosed implementation of the example system, the augmentation is one of an addition to enhance the communication of the information in the converted document, a logical element to guide users to appropriate sections of the converted document, or a data collection element to enable digital data capture. In another disclosed implementation, the augmentation is one of the group of data entry; media display; attached documents; mixed or augmented reality experiences; troubleshooting elements; remote video assistance; remote audio assistance; step name with metadata; quizzes/tests; checklists; table entry; procedure metadata; picker interfaces; bar code or QR scanner; media capture; table displays; picker tables; signature entry; jump; loops to other sections; branches to other sections; escalation; index sections; embedded procedures; biometric; image recognition; and training content. In another disclosed implementation, the method further includes selecting a plurality of converted documents that have similar characteristics to the converted document; and automatically selecting and applying the at least one augmentation to the plurality of converted documents. In another disclosed implementation, the controller is operable to display an authoring interface showing the converted document and a menu allowing selection of the at least one augmentation from a plurality of different augmentations. In another disclosed implementation, the system further includes a network interface communicatively sending the converted document with the augmentation to a user device. In another disclosed implementation, the controller is operable to apply a rule to determine whether the selected augmentation is activated on a display of the user device. In another disclosed implementation, the augmentation accepts input data from a worker associated with the user device, and the input data is sent to a cloud client application in communication with the user device.

Another disclosed example is a computer program product comprising instructions which, when executed by a computer, cause the computer to carry out selecting a document having a description of a sequence of activities. The instructions cause the computer to carry out converting the document into an electronic file format that allows application of an augmentation. The instructions cause the computer to carry out selecting at least one augmentation for the sequence of activities. The instructions cause the computer to carry out applying the selected augmentation to the converted document in the electronic file format.

Another disclosed example is a method for collecting data for implementation of a sequence of activities performed by a user. The sequence of activities is displayed to the user via a user device. An input from the user device is accepted when an activity of the sequence of activities is completed. The time of the input is correlated with the completion of the activity. A performance map is built from the sequence of activities and the times of completion for the user.

In another disclosed implementation of the example method, the sequence of activities includes an augmentation allowing a user to input when the activity of the sequence is completed. In another disclosed implementation, an input of a visible screen coordinate associated with the time of the input from the user device is collected. In another disclosed implementation, the user is one of a plurality of users, and the performance map is built on collection of the completion of the sequence of activities and the times of completion for the plurality of users. In another disclosed implementation, the performance map shows the performance of the user relative to the performances of the plurality of users. In another disclosed implementation, the sequence of activities is one of a plurality of sequence of activities, and the performance map is built on collection of the completion of sequences of activities and the times of completion for the plurality of sequence of activities. In another disclosed implementation, the performance map shows the performance of the sequence of activities relative to the performances of the plurality of sequences of activities.

Another disclosed example is a computer program product comprising instructions which, when executed by a computer, cause the computer to carry out displaying the sequence of activities to a user via user device. The instructions cause the computer to carry out accepting an input from the user when an activity of the sequence of activities is completed. The instructions cause the computer to carry out correlating the time of the input with the completion of the activity. The instructions cause the computer to carry out building a performance map from the sequence of activities and the times of completion for the user.

### DESCRIPTION OF DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating an analytics server, according to example embodiments.

FIG. 3 shows an example of a converted “procedure” supporting dynamic/intelligent augmentations to improve performance and extend functionality produced by an example augmentation system.

FIG. 4 shows an original procedure document augmented by inline content using the example augmentation system.

FIG. 5 shows example rules that may be applied for controlling the display of different augmentations.

FIGS. 6A-6B show an example procedure that has been augmented and the implementation of different example augmentations.

FIGS. 7A-7C show the process of installation of a procedure with augmentations to a user device.

FIG. 8A shows an example authoring interface to add an example augmentation to an ingested document.

FIG. 8B shows an example user device after the added augmentation is deployed to the procedure document displayed by the runtime client on the user device.

FIG. 8C shows the resulting user interaction with the added example augmentation.

FIG. 8D is an example template interface that allows application of augmentations to similar procedural files.

FIG. 9A shows the example authoring interface to add another example augmentation to a converted document.

FIG. 9B shows an example user device after the added augmentation is deployed to the procedure document displayed by the runtime client on the user device.

FIG. 9C shows the resulting user interaction with the added example augmentation.

FIG. 10 shows an example interface displaying performance data collected from worker devices executing a runtime client and communication to a Cloud service during the performance of a procedure.

FIG. 11 is an example interface that compares opportunity of potential time savings in procedures in comparison with all other procedures.

FIG. 12 is an example an example interface that compare the performance of an individual user to all other users in an organization.

### DETAILED DESCRIPTION

Aspects of the invention will be apparent to those of ordinary skill in the art in view of the detailed description of various embodiments, which is made with reference to brief description provided herein.

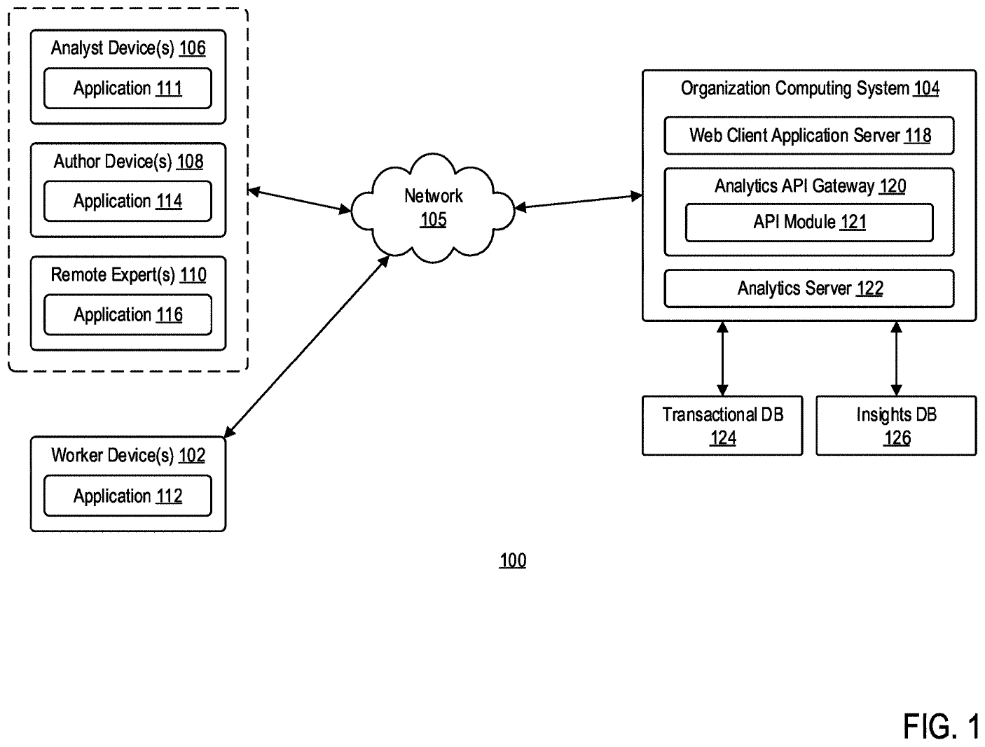

FIG. 1 is a block diagram illustrating a computing environment 100, according to one embodiment. Computing environment 100 may include at least one or more worker devices 102, organization computing system 104, one or more author devices 108, one or more remote experts 110, a transactional database 124, and an insights database 126 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of system 100.

Author device 108 may be representative of computing devices, such as, but not limited to, a mobile device, a tablet, a desktop computer, or any computing system having the capabilities described herein. For example, author device 108 may be any device capable of executing software (e.g., application 114) configured to author work procedures. Author device 108 may include application 114. In some embodiments, application 114 may be representative of a web browser that allows access to a web site. In some embodiments, application 114 may be representative of a stand-alone application. Author device 108 may access application 114 to access functionality of organization computing system 104. In some embodiments, author device 108 may communicate over network 104 to request a web page, for example, from web client application server 118 of organization computing system 104. The content that is displayed to author device 108 may be transmitted from web client application server 118 to author device 108, and subsequently processed by application 114 for display through a graphical user interface (GUI) of author device 108.

Author device 108 may be configured to execute application 118 to generate a new work procedure for assisting workers in performing a hands-on job, such as, but not limited to, equipment service, manufacturing assembly, or machine calibration. Exemplary work procedures may include any combination of text, pictures, movies, three-dimensional computer aided design (3D CAD), remote expert sessions, and mixed reality sessions to aid the worker in completing a task and tracking task completion.

Worker device 102 may be representative of a computer device, such as, but not limited to, a mobile device, a tablet, a desktop computer, a wearable device, smart glasses, or any computing system having the capabilities described herein. For example, worker device 102 may be any device capable of executing software (e.g., application 112) configured to receive and display work procedures generated by an author device 108.

Worker device 102 may include application 112. In some embodiments, application 112 may be representative of a web browser that allows access to a website. In some embodiments, application 112 may be representative of a stand-alone application. Worker device 102 may execute application 112 to access functionality of organization computing system 104. In some embodiments, worker device 102 may communicate over network 105 to request a web page, for example, from web client application server 118 of organization computing system 104. For example, worker device 102 may request a work procedure from web client application server 118 for a particular hands-on job. The content that is displayed to worker device 102 may be transmitted from web client application server 118 to worker device 102, and subsequently processed by application 112 for display through a GUI of worker device 102.

In some embodiments, worker device 102 may be further configured to transmit activity data to organization computing system 104 for review and analysis. For example, via application 112, worker device 102 may transmit high granularity activity data to organization computing system 104, such that organization computing system 104 may analyze the activity data to improve (or optimize) the work procedure. Such high granularity activity data may include, but is not limited to, time it takes the worker to complete each step, whether the worker watched a video included in the work procedure, whether the worker stopped the video included in the work procedure early, whether the worker contacted a remote expert, what problems or questions were raised, whether the remote expert took any action, including making specific suggestions or recommendations, whether the user completed the work procedure, and the like.

Analyst device 106 may be representative of a computing device, such as, but not limited to, a mobile device, a tablet, a desktop computer, or any computing system having the capabilities described herein. For example, analyst device 106 may be any device capable of executing software (e.g., application 111) configured to access organization computing system 104.

Analyst device 106 may include application 111. In some embodiments, application 111 may be representative of a web browser that allows access to a website. In some embodiments, application 111 may be representative of a stand-alone application. Analyst device 106 may execute application 111 to access functionality of organization computing system 104. In some embodiments, analyst device 106 may communicate over network 105 to request a web page, for example, from web client application server 118 of organization computing system 104. The content that is displayed via analyst device 106 may be transmitted from web client application server 118 to analyst device 106, and subsequently processed by application 111 for display through GUI of analyst device 102. In some embodiments, analyst device 106 may act as the access point for data and visualization of that data along with generated insights and recommendations. The Analysts actions and responses to these insights and recommendations, such as dismissing an insight and not taking any action on it. In some embodiments, actions performed by analyst devices 106 may be used as input to the machine learning model to better refine the model's generation of the insights.

Remote expert device 110 may be representative of a computing device, such as, but not limited to, a mobile device, a tablet, a desktop computer, or any computing system having the capabilities described herein. For example, remote expert device 110 may be any device capable of executing software (e.g., application 116) configured to access organization computing system 104.

Remote expert device 110 may include application 116. In some embodiments, application 116 may be representative of a web browser that allows access to a website. In some embodiments, application 116 may be representative of a stand-alone application. Remote expert device 110 may execute application 116 to access functionality or organization computing system. For example, remote expert device 110 may execute application 116 responsive to a request from a worker device 102 for guidance regarding an operation in a work procedure. Via application 116, through organization computing system 104, worker device 102 may be connected with a respective remote expert device 110. For example, in some embodiments, remote expert device 110 may communicate over network 105 to request a web page, for example, from web client application server 118 of organization computing system 104. The content that is displayed to remote expert device 110 may be transmitted from web client application server 118 to author remote expert device, 110 and subsequently processed by application 116 for display through a GUI of remote expert device 110. In other words, remote expert device 110 may enable a worker to stream live video and audio to remote experts. Both the expert and the worker may annotate either the live video or a freeze frame image. In some embodiments, remote expert device 110 may be presented with a complete history of the job that the worker is executing. The complete history may provide remote expert device 110 with the ability to “go back in time” to review the steps that were taken and the data that was input up to the time the remote expert session was established.

In some embodiments, remote expert device 110 may be further configured to transmit activity data to organization computing system 104 for review and analysis. For example, via application 116, remote expert device 110 may transmit high granularity activity data to organization computing system 104, such that organization computing system 104 may analyze the activity data to improve (or optimize) the work procedure, and to improve the selection of remote experts. Such high granularity activity data may include, but is not limited to, the assistance provided to worker device 102 during a respective work procedure, in the formats of audio, video, and text.

Organization computing system 104 may represent a computing platform configured to host a plurality of servers. In some embodiments, organization computing system 104 may be composed of several computing devices. For example, each computing device of organization computing system 104 may serve as a host for a cloud computing architecture, virtual machine, container, and the like.

Organization computing system 104 may include at least web client application server 118, analytics application programming interface (API) gateway 120, and analytics server 122. Web client application server 118 may be configured to host one or more webpages accessible to one or more of analyst device 106, author device 108, remote expert device 110, and/or worker device 102. In some embodiments, web client application server 118 may host one or more webpages that allow an author device 108 to generate a work procedure to be accessed by one or more worker device 102.

In another example, web client application server 118 may host one or more webpages that allow a worker device 102 to access one or more work procedures directed to the worker device 102.

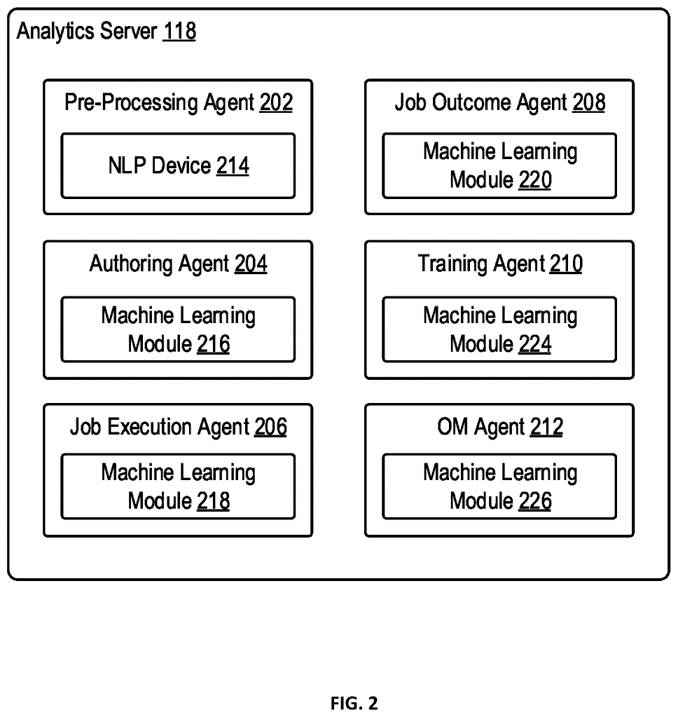

Analytics server 122 may be configured to generate one or more actionable insights based on user activity data. For example, analytics server 122 may consume high resolution data generated by one or more of analyst device 106, author device 108, remote expert device 110, and worker device 102. From the high resolution data, analytics server 122 may be configured to generate one or more actionable insights related to a specific work procedure. Such insights may include, but are not limited to an author index (which may help users assess the needs of the authors and improve their skills, as well as better match their qualifications to the upcoming new tasks), dynamically improved (or optimized) and individualized work instructions for each worker device 102, a true opportunity score, a worker index, and the like. Analytics server 122 is described in more detail below in conjunction with FIG. 2.

Analytics API gateway 120 may be configured to act as an interface between web client application server 118 and analytics server 122. For example, analytics API gateway server 120 may be configured to transmit data collected by web client application server 118 to analytics server 122. Likewise, analytics API gateway server 120 may be configured to transmit insights generated by analytics server 122 to web client application server 118.

Analytics API gateway 120 may include API module 121. API module 121 may include one or more instructions to execute one or more APIs that provide various functionalities related to the operations of organization computing system 104. In some embodiments, API module 121 may include an API adapter that allows API module 121 to interface with and utilize enterprise APIs maintained by organization computing system 104 and/or an associated entity. In some embodiments, APIs may enable organization computing system 104 to communicate with one or more of worker device 102, analyst device 106, author device 108, remote expert device 110, or one or more third party devices.

In some embodiments, data collection and acquisition process provided by organization computing system 104 may include, but is not limited to: data from definition, modification and execution of new and existing procedures, data collected from external sources such as internet of things (IoT) devices, customer relation management (CRM) devices, enterprise resource planning (ERP) devices by means of integrations provided to those systems, data collected from extended resources such as customers associated with organization computing system 104, data through human-in-the-loop feedback mechanism, which provides valuable domain expertise, and the like

Organization computing system 104 may communicate with transactional database 124 and insights database 126. Transactional database 124 may be configured to store raw data received (or retrieved) from one or more of worker devices 102, analyst devices 106, author devices 108, remote expert devices 110, and the like. For example, web client application server 118 may be configured to receive data from one or more of worker devices 102, analyst devices 106, author devices 108, remote expert devices 110 and store that data in transactional database 124. Insights database 126 may be configured to store one or more actionable insights generated by analytics server 122. In operation, for example, analytics API gateway 120 may pull information from transactional database 124 and provide said information to analytics server 122 for further analysis. Upon generating one or more actionable insights via artificial intelligence and machine learning, analytics server 122 may be configured to store the generated insights in insights database 126. Analytics API gateway 120 may, in turn, pull the generated insights from insights database 126 and provide the insights to web client application server 118 for transmission to one or more of analyst device 106, author device 108, and/or worker device 110.

FIG. 2 is a block diagram illustrating analytics server 122 in greater detail, according to example embodiments. As illustrated, analytics server 122 may include pre-processing agent 202, authoring agent 204, job execution agent 206, job outcome agent 208, training agent 210, and operations management (OM) agent 212. Each of pre-processing agent 202, authoring agent 204, job execution agent 206, job outcome agent 208, training agent 210, and OM agent 212 may be comprised of one or more software modules. The one or more software modules may be collections of code or instructions stored on a media (e.g., memory of analytics server 118) that represent a series of machine instructions (e.g., program code) that implements one or more algorithmic steps. Such machine instructions may be the actual computer code the processor of analytics server 118 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of an instruction.

Pre-processing agent 202 may be configured to process data received from one or more of analyst device 106, author device 108, remote expert device 110, and/or client device 102. For example, pre-processing agent 202 may be configured to extract relevant information for the raw data and format it in a way that is compatible with an underlying algorithm, in which the data is used as input. In some embodiments, pre-processing agent 202 may identify up and down times of the work executions, out of ordinary data points, remove irrelevant or noisy data points based upon the feedback from analysts, and the like. In some embodiments, pre-processing agent 202 may further use data enhancement techniques such as, but not limited to, combining data points coming from different versions of work instructions based upon their similarity. Such prepared data may be stored in transactional database 124.

In some embodiments, pre-processing agent 202 may further be configured to extract one or more features from the prepared data. For example, pre-processing agent 202 may be configured to generate one or more data sets for each of authoring agent 204, job execution agent 206, job outcome agent 208, training agent 210, and OM agent 212 by extracting select features from the prepared data. Pre-processing agent 202 may include natural language processor (NLP) device 214. NLP device 214 may be configured to retrieve prepared data from transaction database 124 and scan the prepared data to learn and understand the content contained therein. NLP device 214 may then selectively identify portions of the prepared data that correspond to each respective agent. Based on this identification, pre-processing agent 202 may extract certain features for preparation of a data set for a particular agent.

Authoring agent 204 may be configured to improve the description of the set of activities that may lead to a desired outcome in a work procedure. As stated above, author devices 108 may be configured to define electronic work instructions (e.g., work procedures) in a highly structured, but flexible, way. Such functionality may allow authors to prescribe activities in self-contained chunks that correspond to major steps needed to accomplish an underlying end result. In some embodiments, the steps may be defined through a collection of different units of work (e.g., “cards”). Each card may include, for example, a variety of different avenues for relaying instructions to a worker device 102. Such avenues may include, but are not limited to, text, table, checklist, images, videos, and the like.

One of the key problems in defining electronic work instructions is identifying which methodology provides the best (or optimal) content for the worker. Authoring agent 204 may be configured to aid in reducing the time it takes to reach an “optimal” procedure by providing insights to a work procedure through the use of the underlying procedure definition data, the experience representation (which may be built using historical data of successful work procedures) and correlations with execution patterns. For example, authoring agent 204 may be configured to generate actionable insights about an instruction's impact on the speed of execution, consistency of cycle time, and the quality of outcomes. Authoring agent 204 may generate a unique measure called “author index,” which may help organizations assess the needs of the authors and improve their skills, as well as better match their qualifications to upcoming tasks. Author index may represent a scoring mechanism to assess the process of authoring the electronic work instructions. In some embodiments, the score can be used to compare a given authoring process of a given work instructions for a specific product across other authoring processes of work instructions for similar products in order to identify the improvement opportunities for corresponding authors. This score may provide a benchmark as well as a measurement of goodness of such processes. For example. a given authoring process of a quality assurance (QA) procedure, which may include the number of versions it goes through, the count and types of different steps and cards, the time and quality indicators of the executed tasks can be used to create a score that would fairly compare that process against the authoring process of other similar procedures. This score value may provide insights into how the authoring process to proceed.

Authoring agent 204 may include machine learning module 216. Machine learning module 216 may include one or more instructions to train a prediction model to generate the author index described above. To train the prediction model, machine learning module 120 may receive, as input, one or more sets of training data generated by pre-processing agent 202. The training data utilized by authoring agent 204 may include but is not limited to: the versions of the instructions, the sequence of changes that are made to the instructions over time, number of steps, cards and their types, the way the instructions are expressed in terms of natural language and the style, the execution data in terms of cycle time, quality, and the sequence in which the work instructions are carried out as well as the patterns of up and down times, and the like. Machine learning module 216 may implement one or more machine learning algorithms to train the prediction model to generate the author index. Machine learning module 116 may use one or more of AB testing, a decision tree learning model, association rule learning model, artificial neural network model, deep learning model, inductive logic programming model, support vector machine model, clustering mode, Bayesian network model, reinforcement learning model, representational learning model, similarity and metric learning model, rule based machine learning model, and the like to train the prediction model.

Job execution agent 206 may be configured to generate one or more actionable insights for improving (or optimizing) work instructions for a given worker device 102. One of the main challenges in human-centric-processes is the inherent variability of the humans. Such variability may place a huge strain on predictive systems that may be used for planning purposes. On the other hand, humans also provide flexibility to the system. For example, by employing workers rather than automated machines, a manufacturing organization may provide a huge variety of offerings. When author device 106, for example, generates a work procedure, the author may attempt to strike a balance between variability and flexibility. For example, such electronic work procedures may allow a user to standardize how the work should be accomplished, while also allowing for individualization as to how the instructions are delivered to respective worker devices 102.

Job execution agent 206 may be configured to continuously measure the “goodness” of the executions of underlying instructions. For example, job execution agent 206 may include machine learning module 218. Machine learning module 218 may include one or more instructions to train a prediction model to generate one or more actionable insights for improving work instructions for a given worker device 102. To train the prediction model, machine learning module 218 may receive, as input, one or more sets of training data generated by pre-processing agent 202. The training data utilized by authoring agent 204 may include up and down times, utilization of various media helpers, the order in which instructions are carried out, underlying experience and historical performance of the workers, worker's year of experience with the organization, the skill improvement training each worker has participated in, and the like. Machine learning module 218 may implement one or more machine learning algorithms to train the prediction model to generate a score associated with the quality of the instructions in a work procedure. For example, instead of machine learning module 218 may generate a quality of fit for a given worker is as a way to individualize the work instructions in such that they best serve the workers. Machine learning module 218 may use one or more, a decision tree learning model, association rule learning model, artificial neural network model, deep learning model, inductive logic programming model, support vector machine model, clustering mode, Bayesian network model, reinforcement learning model, representational learning model, similarity and metric learning model, rule based machine learning model, and the like to train the prediction model.

Based on the value generated by job execution agent 206, the system may be configured to provide dynamically optimized and individualized work instructions to enable each worker device to perform each time in the least amount of time possible, while achieving quality, safety, and productivity goals. In some embodiments, to achieve such dynamic optimization goal, the system may use techniques that involve, but are not limited to, exhibition or concealment of certain helper content, providing training refreshers, switching from verbose or succinct versions of the instructions, variations in the order in which steps are presented, and the like.

In some embodiments, job execution agent 206 may further provide unique insights into how the underlying worker execution fits with the set of identified goals, what kind of automatic interventions have been applied, and what kind of results have been attained from them. For example, consider a scenario in which five hundred units of the same product needs to be assembled for a given job order with certain time and quality targets. Job execution agent 206 may dynamically monitor the underlying executions and alter the details of the instructions provided to the user based upon that data. For example, given a worker establishing a good time average for the cycle time, he/she may no longer need the most detailed version of the instructions. Accordingly, job execution agent 206 may automatically make this switch. Similarly. a worker not establishing the required quality target can dynamically be provided with extended video instructions on the problematic step. In addition, the impact of these interventions may be provided to the stakeholders as insights for further training of workers or enhancement of work instructions.

Job outcome agent 208 may be configured to generate an opportunity value for a work procedure. One of the issues with human centric processes is the difficulty in collecting relevant data related to said human activities. Traditionally, conventional systems used time and motion studies, essentially watching a person do their job for a short period of time and then analyzing this data to identify what needed to be changed to increase productivity. Such techniques are typically expensive, intrusive to operations, and one-shot efforts. Job outcome agent 208 is configured to provide a unique solution that eliminates the downfalls of conventional systems. For example, through the use of granularity data transmitted by worker devices 102 to organization computing system 104, job outcome agent 208 may be configured to generate an opportunity value.

Job outcome agent 208 may include machine learning module 220. Machine learning module 220 may be configured to generate a raw opportunity score. For example, machine learning module 220 may include one or more instructions to train a prediction model to generate the raw opportunity score. To train the prediction model, machine learning module 220 may receive, as input, one or more sets of training data generated by pre-processing agent 202. The training data utilized by job outcome agent 208 may include, but is not limited to, time spent on productive and non-productive sections of each card (or step), the information related to the identity of the worker device 102, status and quality of the underlying products that are being worked on, historical performance of the workers, the corresponding tools involved in the operation, and the like. Using this data, prediction model may be trained to identify a raw opportunity score.

From the raw opportunity score, job outcome agent 208 may generate a true opportunity score (also known as a true productivity score). For example, machine learning model 220 may further train the prediction model to generate the true opportunity using one or more machine learning algorithms. Machine learning module 220 may use one or more, a decision tree learning model, association rule learning model, artificial neural network model, deep learning model, inductive logic programming model, support vector machine model, clustering mode, Bayesian network model, reinforcement learning model, representational learning model, similarity and metric learning model, rule-based machine learning model, and the like to train the prediction model. The true opportunity score may be determined against a data driven benchmarks using techniques that involve, but are not limited to, identification and exclusion of noisy data points, adjustments taking into account the historical performance of the agent's quality, and resource state indicators.

In some embodiments, the true opportunity score may be continuously updated as more data is available to the system. Accordingly, job outcome agent 208 may provide a forward looking value that may be attained as a productivity improvement. Moreover, in some embodiments, job outcome agent 208 may qualify this score in terms of how much effort it would involve for the productivity improvement. This effort value may be attributed to various interventions that need to be done, such as, but not limited to, training required for the works or enhancements that should be made to the underlying procedure.

Training agent 210 may be configured to generate a worker index, which may quantify the learning needs and performance index of each worker (e.g., worker device 102). Generally, matching workers' skills to underlying tasks is a challenging process. Such process becomes convoluted due to the constant changes in the workforce and product requirements. For example, identifying, measuring, and meeting the learning needs of the workforce typically depends on a comprehensive evaluation of the individuals, the tasks, and the way in which the individuals are instructed to carry out those tasks.

Training agent 210 improves upon conventional systems by generating a multidimensional representation of the current state of the worker (e.g., associate/agent) in relation to the relative complexity of the activities involved in the current tasks that the given individual is assigned by making use of attributes of the worker and historical execution data collected by the platform. This representation of the worker may be used to quantify the learning needs and the performance index of the worker, i.e., the worker index. This score may constitute the basis for the continuous assessment of the training needs of each worker.

To generate the worker index, training agent 210 may include machine learning module 224. Machine learning module 224 may include one or more instructions to train a prediction model to generate the worker index described above. To train the prediction model, machine learning module 224 may receive, as input, one or more sets of training data generated by pre-processing agent 202. The training data utilized by machine learning module 224 may include, but is not limited to, attributes of each agent and historical execution data (e.g., including experience level for the underlying tools and the resources required). Machine learning module 224 may implement one or more machine learning algorithms to train the prediction model to generate the worker index for each worker device 102. Machine learning module 224 may use one or more, a decision tree learning model, association rule learning model, artificial neural network model, deep learning model, inductive logic programming model, support vector machine model, clustering mode, Bayesian network model, reinforcement learning model, representational learning model, similarity and metric learning model, rule based machine learning model, and the like to train the prediction model.

By continuous updating (or optimization) of the worker index, training agent 210 may provide guidance to the key stakeholders in terms of actionable insights with an intuitive interface, such that the workforce is supported by relevant training at the right time.

OM agent 212 may be configured to generate one or more decisions into prescriptive issues. For example, OM agent 212 may assign a set of works to an upcoming demand based on, for example, lead times, order quantities, resource utilization requirements, electronic work instructions, worker historical performances, and the like. Generally, organizations receive a greater benefit out of their improvement efforts when the entire system, as a whole, is considered. When goals are set at a high level, incorporating those constraints that connect multiple components increase the utility of the overall system. Through integrations with external data sources, such as enterprise resource planning, organization computing system 104 may be able to create a system level view. In some embodiments, the system level view takes into account the operations as a whole in a given organization including various job orders, shared resources in terms of workers and equipment, as well as lead times of materials involved and the shipment dates. In some embodiments, the system level view may be created through connections to other systems the organization uses for those purposes such as ERP systems.

OM agent 212 may be configured to utilize this system level view to formulate key decisions into prescriptive problems. For example, the system level view may correspond to the data that enables the application to formulate such problems that improves (or optimizes) a goal function, subject to constraints that ties together the resources in general. An example of a key decision may be the assignment of workers to stations. The prescriptive problem that this decision corresponds may be to minimize the lead time or maximize the utilization of a certain equipment etc. For example, OM agent 212 may be configured to generate key decisions about workforce scheduling by taking into account demand and lead time constraints. Such key decisions may provide preventive maintenance decisions making use of the utilization and performance data through workers' cycle time. For example, data collected through IOT systems and ERP systems may be merged together with the frontline worker performance data, thereby providing input into determining when or if an equipment should undergo a preventive maintenance in order to avert a future outage.

OM agent 212 may include machine learning module 226. Machine learning module 222 may include one or more instructions to train a prediction model to generate the key decisions described above. To train the prediction model, machine learning module 226 may receive, as input, one or more sets of training data generated by pre-processing agent 202. The training data utilized by authoring agent 204 may include information collected from third party software that organizations may use to manage the operations that are not captured by organization computing system. Such data may be collected via TOT, ERP, or CRM systems and combined together with the proprietary data collected or generated by organization computing system 104, such as, but not limited to, cycle time, historical performance, resource utilization, etc. Machine learning module 226 may implement one or more machine learning algorithms to train the prediction model to generate the key decisions. Machine learning module 226 may use one or more, a decision tree learning model, association rule learning model, artificial neural network model, deep learning model, inductive logic programming model, support vector machine model, clustering mode, Bayesian network model, reinforcement learning model, representational learning model, similarity and metric learning model, rule-based machine learning model, and the like to train the prediction model.

The present disclosure relates to a method and system for converting existing content (e.g., PDF documents, Word documents, PowerPoint documents) that describes a sequence of activities like work instructions, maintenance, repair, assembly, Standard Operating procedures, Quality forms, into a form “Procedure” file format that enables users to add intelligent augmentations to the sequence of activities to improve the effectiveness of a Procedure when executed. The resulting file may be considered an electronic document or file that may be transmitted to other devices such as the worker device 102 in FIG. 1. The procedure file format is designed to run natively in a runtime environment/client which enables high-resolution time tracking of location within the original document as a worker follows the sequence of activities on the user device 102. These time/location events are streamed to the performance engine in the cloud service 304. The procedure file format also allows the ability to add augmentations inline or “on top of” the original document to enable better understanding of the procedure by the worker, and to add data collection elements to the static source document. In this example, the procedure file format is a proprietary JSON format, but other formats that allow the ability to add augmentations may be used. The conversion process may be performed by the authoring device 108 in FIG. 1.

Once documents are converted into this new format, users such as a user of the authoring device 108 can add performance-linked augmentations to enhance the effectiveness of the document to increase user performance and process outcomes. An augmentation is generally defined as an addition to an electronic image of a document designed to enhance the communication of the information in the document, a logical element to guide users to appropriate sections of the document, or a data collection element to enable digital data capture. Thus, an augmentation has one or more of the following attributes; it provides media elements to make an activity more understandable (video, picture, augmented reality experience, etc.); it may include a data collection element to allow digital data collection to support compliance, quality, inventory, maintenance, operations needs (e-signature, data entry, visual inspection, maintenance defects, etc.), it may include a logical element to dynamically control the sequence of activities presented to the worker to optimize the procedure for a specific operation or worker (branching, looping, jump to, make visible, etc.). Augmentations are created anywhere in the document such as an augmentation embedded inline of the document or as an overlay. Each of these augmentations are controlled by a performance engine on a server such as the server 118 in FIG. 1, which can control attributes of the augmentation. Example controls include: a) will the augmentation be visible or invisible; b) will the augmentation be required to be executed or optional; and c) will the augmentation require a second person to sign off prior to advancing in the procedure.

These attributes can be controlled based on a multitude of factors embodied in a rule. The factors may include prior performance of the user on this procedure; AI calculated “True Performance” (also known as true proficiency) of a user on the procedure (see e.g., U.S. Pat. No. 11,423,346); recency of last time this user executed this procedure; total number of times the user has executed this procedure; random selection; metadata about user (e.g., user role, years of experience, etc.); purpose of this execution of the procedure (e.g., training, production, etc.); data captured earlier in the procedure; absolute date; shift number; and user location.

Augmentations can be added to a procedure file for a variety of different reasons. Augmentations may be added to add data collection capability to a static document to create electronic data that is more easily managed and reported upon. Augmentations may be added to add richer content like images, movies, augmented reality, etc., to help make the document file more understandable so that the user can complete the task safely and correctly, and in the least possible time. Augmentation may be used to add quizzes to test knowledge when content is used for training. Augmentation may be used to add logical branching to route users to the most pertinent content based on data collected earlier in the procedure (e.g., content for repairing a car would route to the engine section based on answers to questions asked earlier in the procedure). Augmentations may be added to assist in troubleshooting to help a user solve a problem independently and efficiently. Augmentations may be added to add in line training content to provide learning support in the moment of need. Augmentations may be added to add media capture (such as digital video) to document situations for compliance or training material

Example augmentations to a procedure may include: Data Entry; Media Display (picture, video, gif, etc.); Attached Documents; Mixed or Augmented Reality Experiences; Troubleshooting Elements; Remote Video/Audio Assistance; Step Name with MetaData; Quizzes/Tests; Checklists; Table Entry; Procedure Metadata; Picker interfaces; bar code or QR scanner; Media Capture; Table Displays; Picker Tables; Signature entry; logical jumps; loops to other sections; branches to other sections; escalation and notifications to other users; index sections; embedded procedures; Biometric security; Image Recognition; and Training content.

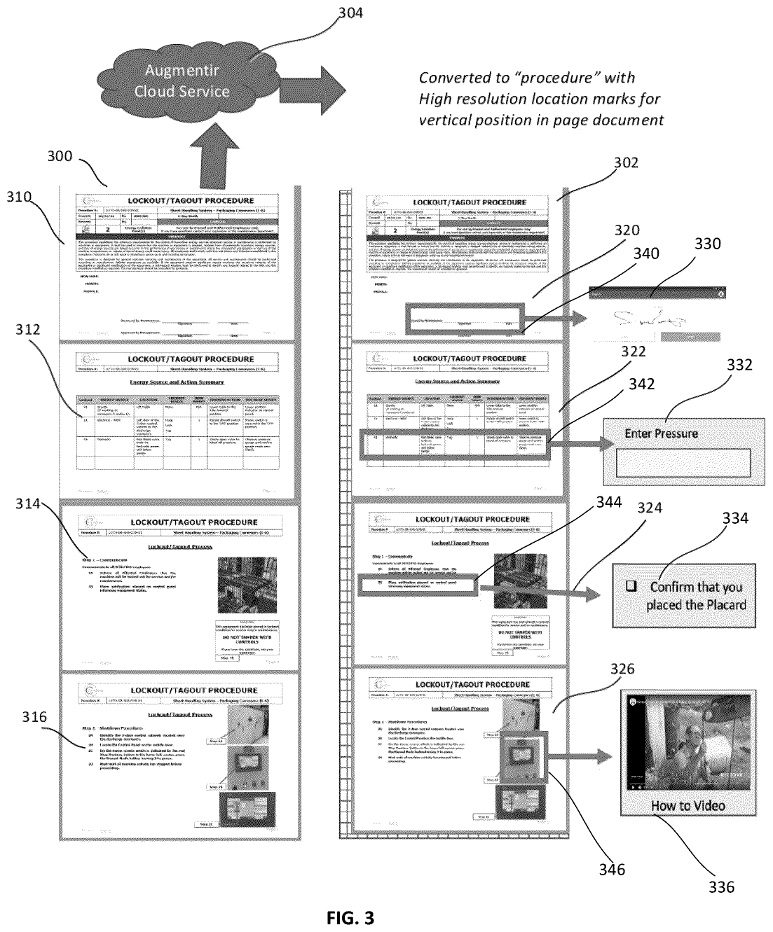

FIG. 3 shows the general process of a document 300 that is converted to a “procedure” file 302 supporting dynamic/intelligent augmentations to improve performance extend functionality. A Cloud service application 304 may be accessed by a device such as the authoring device 108 to convert an existing media of procedures such as a document 300. The document 300 may be in well known application formats such as pdf, Word or Powerpoint and may be ingested by the Cloud service application 304. FIG. 3 is an example of how the conversion process that adds high resolution performance marks to the document 300 to enable AI/ML based algorithmic performance measurement and logical operation prediction as will be explained below.

The document 300 includes different pages that describe a procedure such as a lockout/tagout procedure. The pages include a first page 310 that describes the purpose of the procedure with a required set of signatures. A second page 312 describes the energy source and action summary for the procedure. A third page 314 and a fourth page 316 provide detailed step instructions for the procedure.

The procedure file 302 includes corresponding pages 320, 322, 324 and 326 that have augmentations added. Thus, the procedure file 302 may be displayed on a user device such as the user device 102 in FIG. 1. The activations of the augmentations result in recording data related to the procedure as well as data that may be used to analyze performance. In this example, a series of augmentations 330, 332, 334, and 336 have been added to respective different pages 320, 322, 324, and 326 of the procedure file 302. As will be explained below, the augmentations 330, 332, 334, and 336 may be activated by respective markings 340, 342, 344, and 346 that are added to the respective pages 320, 322, 324, and 326. Thus, a worker may activate the example signature box augmentation 330 through selecting the marking 340 on the page 320. A worker may activate the example data entry augmentation 332 through selecting the marking 342 on the page 322. A worker may activate the example check box augmentation 334 through selecting the marking 344 on the page 324. A worker may select the example media augmentation 336 through selecting the marking 346 on the page 326.

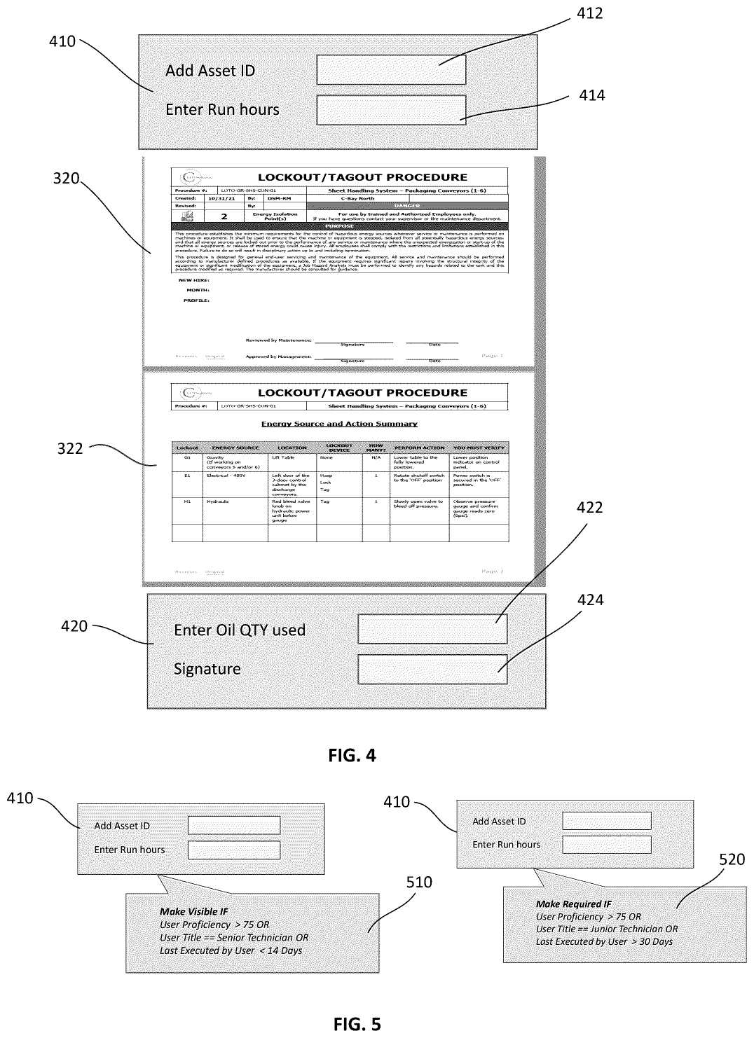

FIG. 4 shows an original procedure file such as the procedure file 302 in FIG. 3 that has been modified by inline content using the example augmentation system executed by the Cloud 304. FIG. 4 is an example of an authoring environment that allows a user to add augmentations in line or overlaid anywhere on the procedure. In this example, the augmentation software 304 is Cloud based. Thus, the original document 300 may be converted by providing the original document to the augmentation software 304. The augmentations may be integrated with the created procedure file 302 that may be made available through the cloud to devices such as the worker device 102.

In the example shown in FIG. 4, the system allows augmentation of the pages 320 and 322 in FIG. 3 that are converted from pages 310 and 312. The first page 320 is augmented with a fill in field 410. In this example, the fill in field 410 includes an asset ID field 412 and an enter run hours field 414. The augmentation of the fill in field 410 thus allows the procedure document 302 to collect data on the asset ID field and the run hours when the page 320 is displayed to a user. Another fill in field 420 is used to augment the second page 322. The fill in field 420 includes an enter oil quantity used field 422 and a signature field 424. The fill in field 420 thus allows the procedure file 302 to collect data for the oil quantity and a verification signature from the worker.

FIG. 5 shows example rules that may be applied for controlling the display of different augmentations. Each augmentation is intelligently controlled from the augmentation service 304 executed on the Cloud and delivered to the local runtime client application. Control of an augmentation includes whether the augmentation is made visible to a user, and, if visible, whether it is required or optional.

In this example, the augmentation is a data entry augmentation such as the fill in field 410 in FIG. 4 that augments the first page 320. FIG. 5 shows an example rules interface 510 that may be used to apply a rule. Authors have to the ability to build simple or complex rules using a live expression editor or using JavaScript in this example. The example rule that displays the augmentation is based on the proficiency of the user, whether the title of user is senor technician, or if the procedure was last executed in a two-week period. Thus, factors that determine these properties in rules to control the augmentation can include: the calculated proficiency of the user at this procedure; the number of times the procedure has been executed by this user; the skill certifications of the user, the number of days since procedure has been executed by a specific user, and the title of the user. When the factors are met, e.g., the user proficiency is over 75 OR, the user is a senior technician, and the field was last executed by the user less than 14 days ago. In this example, proficiency is determined by an AI-based algorithm that compares how quickly and correctly one worker performs an activity vs all workers that have performed the same activity within a period of time. Of course other methods may be used to determine a proficiency score for a worker. The above described factors are used to predict how much guidance a worker will need to execute a procedure at their optimum efficiency. Other factors can include skill level certification, random assignment, and total number of times a procedure has been performed by an individual worker.

The rules may be changed or edited for different types of workers. For example, another example rules interface 520 is shown in FIG. 5 that displays the augmentation 410 based on the proficiency of the user, whether the title of user is a junior technician, or if the procedure was last executed more than 30 days ago. The user must have a proficiency over 75 OR such as the factor in the rules interface 510. However, some of the factors rules in the rules interface 520 are different from those in the rules interface 510. For example, the title of the user is now a junior technician and the number of days since procedure has been executed by a specific user has been changed to greater than 30 days. Every augmentation can have a different set of rules but the same rules are applied for each worker for the same augmentation, and based on the individual characteristics of a worker, different outcomes in providing the augmentation may occur.

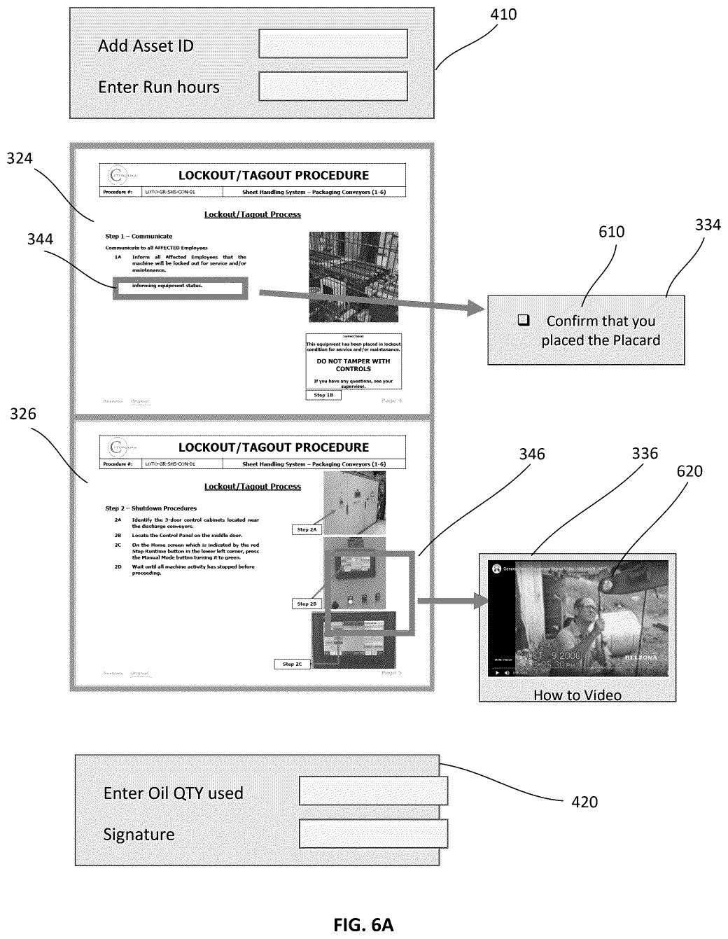

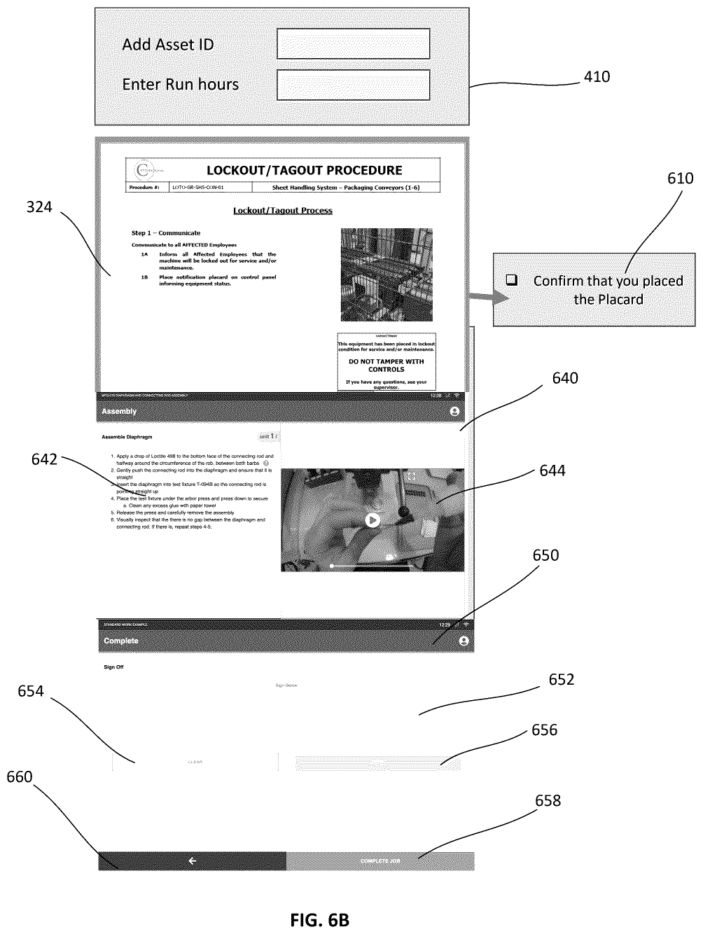

FIG. 6A-6B show an example procedure that has been augmented and the implementation of different example augmentations in relation to the procedure file 302 in FIG. 3. FIG. 6A-6B shows the check box pop up augmentation 334 and a media augmentation such as the augmentation 336. A check box pop up box 610 is assigned to the area marking 344 of the document page 324. The page 324 explains a first step of the procedure (communication) when displayed by a user. The check box pop up 610 is a check box that confirms that the user placed a placard in the step of the procedure. Thus, the worker would see the augmentation marker 344 when the document page 324 is displayed. In this example, the worker would not be able to scroll past the augmentation marker 344 without confirming that the Lockout/Tagout placard has been placed through the check box pop up 610. In this example, the check box pop up 610 is a safety confirmation that prevents other users from inadvertently turning the power on to a machine that is being serviced in the example procedure.

Another example is overlaid content that allows a user to know that help content in the form of a video 620 is available through the overlaid marker 346 on the document page 326. FIG. 6A shows the page 326 that explains the next step of the procedure named “Shutdown.” One of the steps includes the marker 346 that presents the user an optional link to activate the augmentation 336 play the video 620 that demonstrates how to perform one of the steps of the procedure. Another augmentation is a confirmation that the procedure has been completed by requiring the user to enter their signature or other means such as a check off box.

FIG. 6B shows the process of additional augmentations on the example procedure file 302. The example page 324 may have a popup field 640 that includes a detailed instruction field 642 and a video 644 that may be accessed from the page 324 by the user. A fill in form augmentation 650 may also be accessed. The fill-in augmentation 650 includes a sign off field 652 that may accept an actual signature from a user. This is presented to the worker via the display and the worker cannot complete the procedure until they have entered their signature. A clear button 654 allows the worker to clear their signature, while a confirm button 656 allows the worker to upload their signature provided in the sign off field 652. A complete job tab 658 allows the worker to signal that the work has been completed, exiting them from the procedure and stopping all time keeping events An arrow key 660 allows the worker to go back to a prior step.

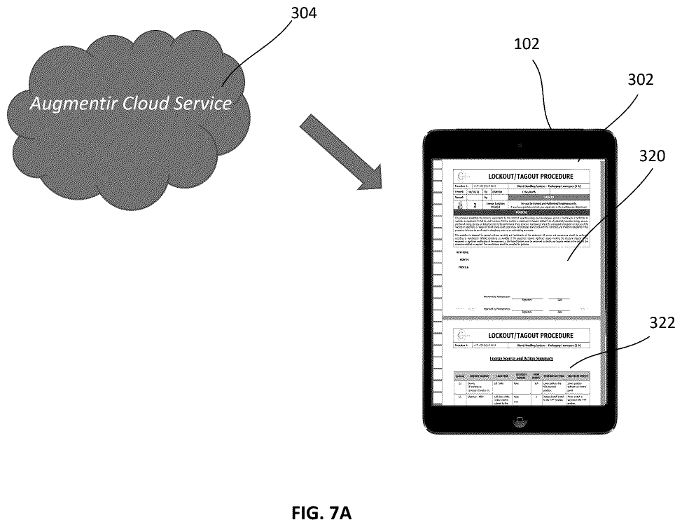

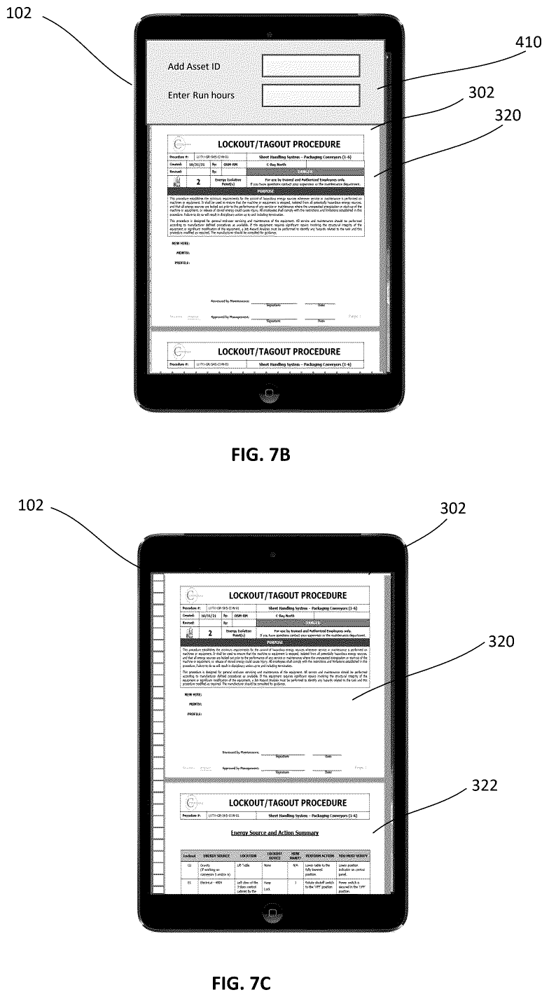

FIG. 7A shows the process of installation of a procedure with augmentations such as the procedure 302 to a user device such as the worker device 102 in FIG. 1. The Cloud based server application 304 downloads the procedure file 302 to the runtime client on the user device 102. The Cloud based service application 304 executed by the server provides data to control the behavior of the augmentations. For example, the control data rules may make the augmentation visible or invisible by the runtime client on the user device 102. The runtime client may also collect data on user performance of the procedure. The user device 102 shows pages 320 and 322 of the procedure file 302 in this example.

FIG. 7B shows an example user device 102 with the procedure file 302 displayed. In this example, the Cloud based service 304 implements a control data rule specified in FIG. 5 for the user. Thus, the pop field 410 is displayed with the page 320 as the user meets the factors for the control data rule. FIG. 7C shows the same page 320 of the procedure file 302 displayed on the user device 102 without the pop up field as the example user does not meet the factors of the control data rule for displaying the pop up field 410.

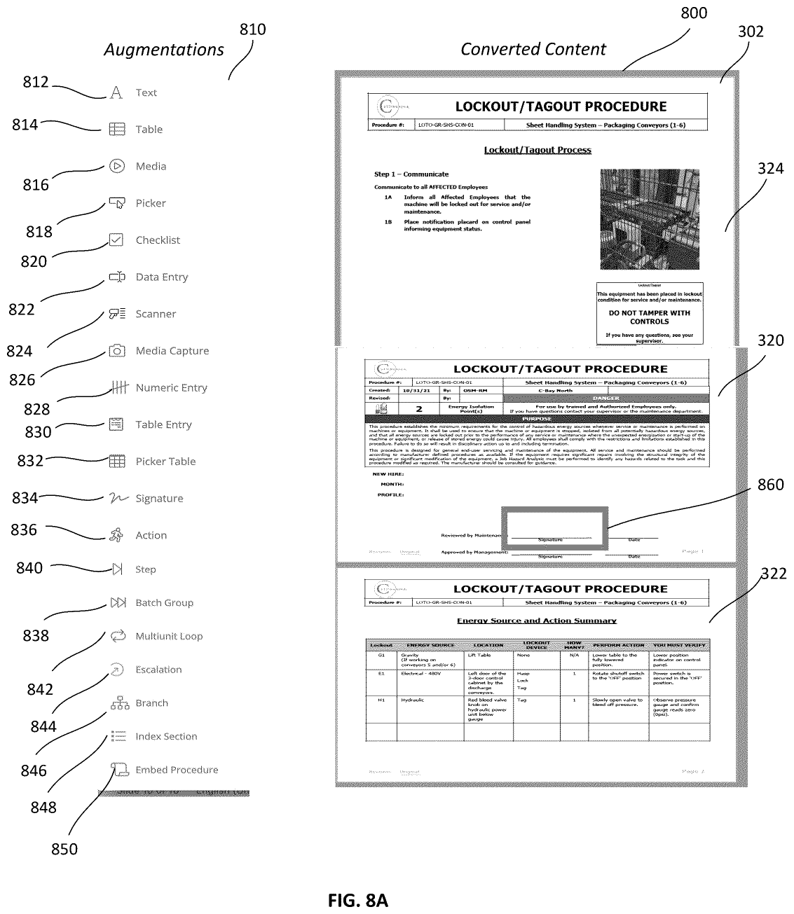

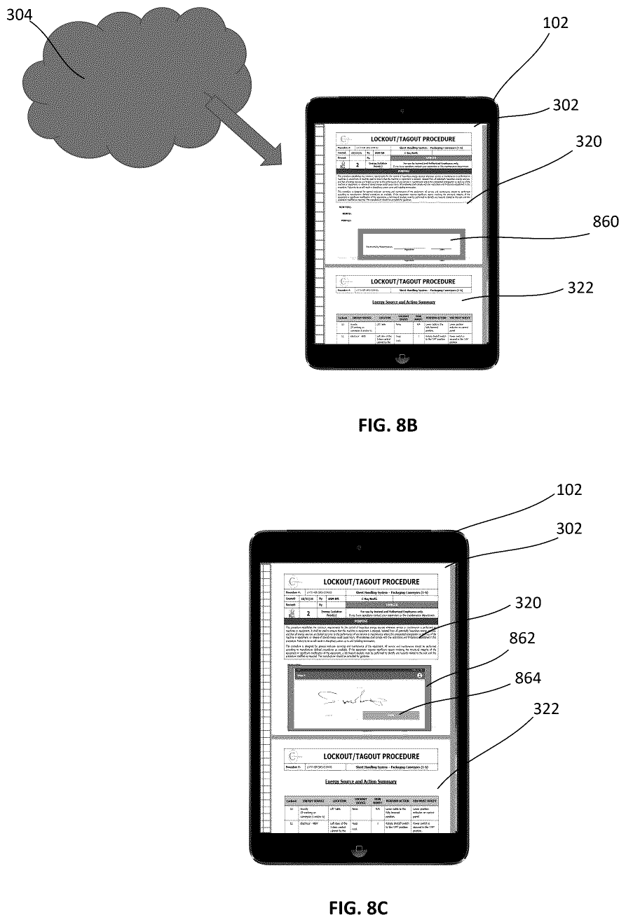

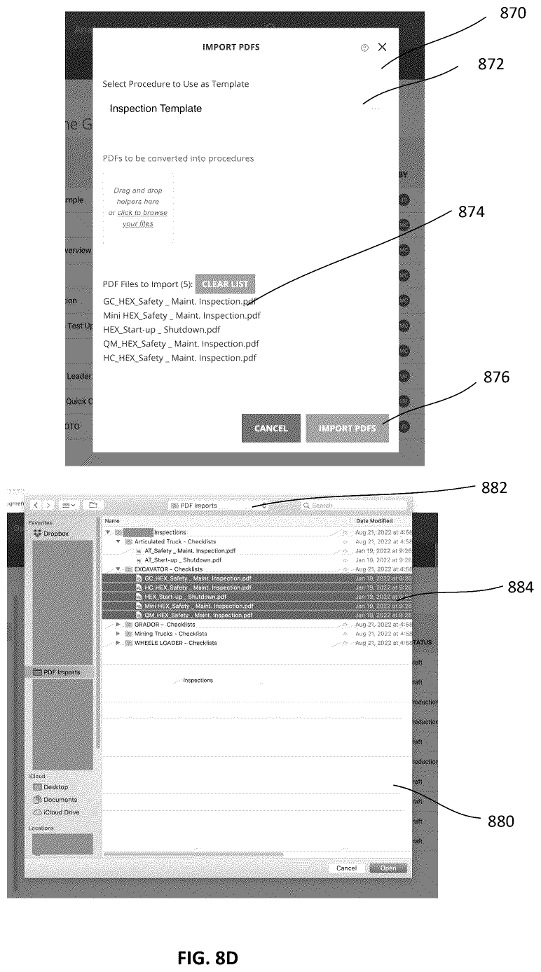

FIGS. 8A-8C shows a process for adding augmentations and uploading augmentations to the procedure file displayed on a user device. FIG. 8A shows an example authoring interface 800 that may be displayed on the authoring device 108 to add augmentation to a converted document. The interface includes a menu 810 that includes a list of augmentations. A user first selects an augmentation from the menu 810.

In this example, the menu 810 includes a text selection 812, a table selection 814, a media display selection 816, a picker selection 818, a checklist selection 820, a data entry selection 822, a scanner selection 824, a media capture selection 826, a numeric entry selection 828, a table entry selection 830, a picker table selection 832, a signature selection 834, an action selection 836, a step selection 838, a batch group selection 840, a multi-unit loop selection 842, an escalation selection 844, a branch selection 846, an index section selection 848, and an embed procedure selection 850.

The text selection 812 enables text or a numeric display to be inserted in a document page. The table selection 814 enables complex, table-based user interfaces to be created and inserted in a document page. The media display selection 816 enables images, GIFs, videos to be displayed from a document page. The picker selection 818 enables a list of choices where one or more can be picked by a worker to be inserted on a document page. The checklist selection 820 enables an author to create a checklist with 1-N entries to be inserted on a document page. The data entry selection 822 enables text and numeric data collection fields to be inserted on a document page. The scanner selection 824 enables data to be entered vis a barcode or a QR code scanned from a prompt inserted on a document page. The media capture selection 826 enables pictures or videos to be taken from the worker device 102 and included in the data collection of the procedure from a prompt inserted on a document page. The numeric entry selection 828 enables selection from a series of numeric items to be inserted on a document page. The table entry selection 830 enables complex, table-based user interfaces to be created where each cell in the table can incorporate any of the other augmentations. The picker table selection 832 enables a list of choices in a table where one or more can be picked to be inserted on a document page. The signature selection 834 enables hand written digital signatures via a prompt inserted on a document page. The action selection 836 enables logical actions like jump to a new area, call an external API, start a new procedure, transfer this procedure to another user to be inserted on a document page. The step selection 838 enables an author to add a logical area to the procedure file. The batch group selection 840 enables the author to select a group of items to execute on a document page. The multi-unit loop selection 842 enables the worker to loop thru the same section of a procedure 1-N times based on an inserted prompt on a document page. The escalation selection 844 causes an escalation to a supervisor or other user for confirmation based on a prompt inserted on a document page. The branch selection 846 enables the creation of logical branches in the procedure on a document page. The index section selection 848 creates a table of contents for navigation through the document. The embed procedure selection 850 enables another procedure file to be embedded/called from this procedure file.

After selection of the augmentation such as the selection of the signature selection 834 in this example, the author may then select a location 860 to place the augmentation on the document page 320. Alternatively, the author may designate the augmentation to be popped up or linked in the document page. Using the menu 810 on the interface 800, the author may place and program as many augmentations as desired on the procedure file 302.

FIG. 8B shows an example user device such as the worker device 102 after the added augmentation in FIG. 8A is deployed from the Cloud 304 to the page 320 of procedure file 302 displayed by the runtime client on the user device. The location 860 is highlighted to the user for entry of a signature on the augmentation added to the page 320.

FIG. 8C shows the resulting user interaction with the added augmentation. In this example, a signature box augmentation 862 has been added and displayed on the user device 102. The runtime client displays the signature box 862 and allows the user to apply their signature. The signature may be recorded by selecting the confirm button 864. New versions of procedure files are automatically loaded to a device from the Cloud service application 304 when they have been edited, approved, and published.

FIG. 8D shows another interface 870 that may be accessed from the interface 800 to allow an author to automatically select and apply the selected augmentation to the other procedural files generated from other instruction documents. The interface 870 is used to select a procedure template that has been used to augment another document file. The interface 870 includes a selection field 872 that allows an author to select a procedure template that contains the augmentations that the author wishes to apply to one or more documents files that have similar functionality or characteristics to one another. The documents files listed in the selection field 874 may have similar functionality or pages as the current procedure template. The interface 870 allows an author to either drag files or access an interface 880 to select files to apply the selected augmentation from the current procedure template to the other procedural files generated from other instruction documents. A file list in the selection field 874 lists the files that are to be imported from the template. Once the file list is complete, the author may apply the file via an import button 876.

The interface 880 includes a document selection field 882. The selection field 882 lists the different types of procedure templates. The author can select the type of augmentation to apply to the list 874 in the interface 870. Files of the augmentation type are listed in a file field 884 for selection. When a procedure template is selected in the selection field 882, this applies a common set of augmentations to the documents listed to the selection field 874. The author may thus select the augmentations that will be applied to the other document files which end up creating procedure files with identical augmentations.

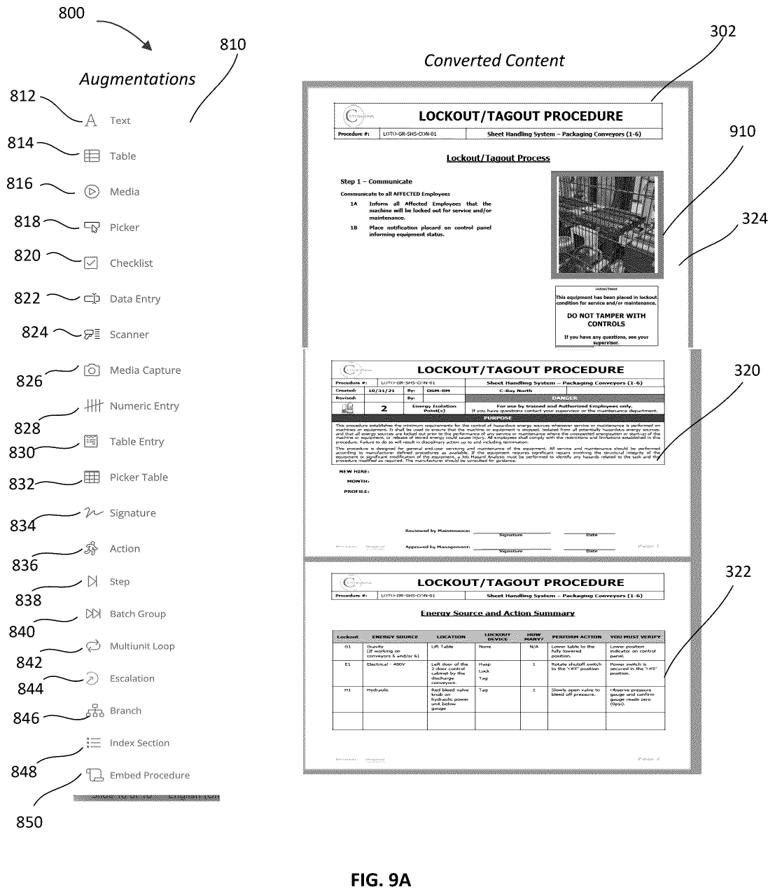

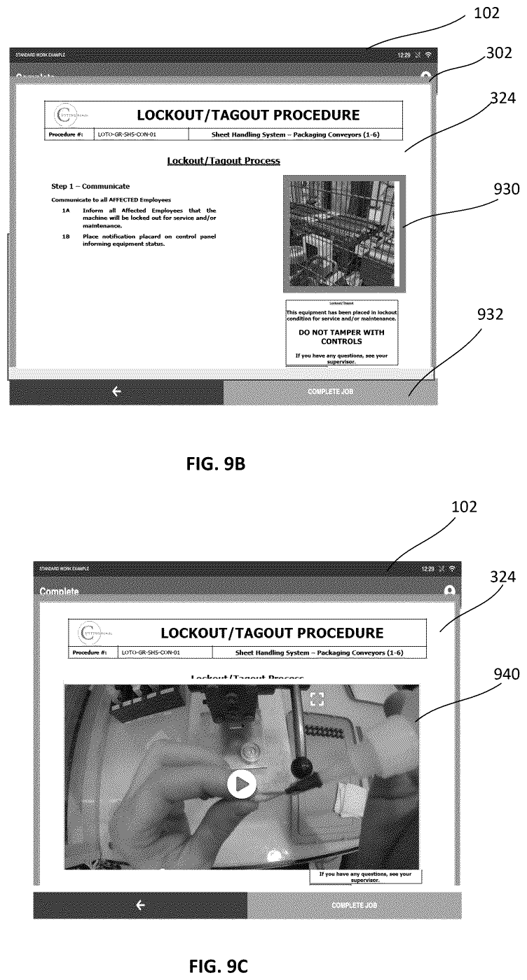

FIGS. 9A-9C shows another process for adding another example augmentation and uploading the augmentation to a user device. FIG. 9A shows the example authoring interface 800 in FIG. 8A where a user selects an example media augmentation selection 816 from the menu 810. The user may then select a location 910 to place the media augmentation on the page 324 of the procedure file 302. In this example, the augmentation selection 816 allows a user to upload a media file such as a video file that is attached to the page 324.

FIG. 9B shows an example user device 102 after the added augmentation in FIG. 9A is deployed to the procedure file 302 displayed by the runtime client on the user device 102. FIG. 9B shows an indication 930 that allows activation of the media augmentation. The interface displays a complete job button 932 that may be selected by the user when they are done with the procedure. The complete job button 932 ends the procedure and stops all data collection and time collection and changes the status of it to “complete” for purposes of recording data relating to worker performance of the procedure. FIG. 9C shows the resulting user interaction with the added augmentation. In this example, the media selected via the interface 800 is played in a window 940. The runtime client displays and plays the media in the window 940.

As explained above, the Cloud based augmentation system in FIGS. 3-9 allows a user to take an existing document (PDF, Word, PPT, etc.) that describes a sequence of activities like work instructions, maintenance, repair, assembly, and automatically convert the document into a form “Procedure” file that adds high resolution tracking elements that stream the progression of a user through the work procedure in order to provide performance analysis of the procedure and the user. Initially, the performance analysis may be based on tracking a location that aligns to the location within the document, however, over time the AI engine may recognize areas of grouped activities (steps) from the patterns in the data and then present performance data related to these steps. In this example, each worker downloads the procedure file 302 from the cloud application 304 to a worker device. The client on the worker device collects data from the worker device while the worker performs the procedure instructed by the procedure file displayed on the worker device. The worker may enter various data during the process. Other data relating to worker performance of the procedure is also collected. This data is aggregated by the client Cloud service application 304 in the Cloud.

The steps in a procedure represent a grouping of activities around a purpose. For example, a procedure of changing the oil in a car may have steps that are eventually be determined to be Step 1: Check Oil Level; Step 2: Remove Oil Filter and Drain Oil; Step 3: Add new oil; Step 4: Check Oil Level. The performance data from performance of the procedure may be used to understand the relative performance of each user versus the entire group of users for this procedure. The performance data may be used for purposes of training recommendations, compensation, job promotion and the like. Additionally, this data may be used when comparing the execution of each procedure in relation to all other procedures being monitored by the system to determine which procedures offer the largest opportunity for performance improvement

The system in FIG. 1 performs the process of collecting and displaying performance data from a user device 102 executing a runtime client and communication to the Cloud service application 304. The completed procedure that may include augmentations as described above is loaded from the Cloud service application 304 to a user device such as the worker device 102. The runtime client on the worker device 102 streams time, visible screen coordinates, and location events as the user moves through the procedure. The collected time, screen coordinates, and location event data is collected by an AI performance engine executed by the Cloud service application 304. The visible screen coordinates record the area of the displayed procedure at specific times relating to performance of the procedure. The system allows automated or manual ingesting of the existing content and automatically add high resolution “progress labels” so that when executed in the runtime client high granularity time events that include visible screen coordinates are returned.

An Al Performance service builds a performance map for every worker performing a procedure across multiple executions. Each time the procedure is run, data on time and location events are streamed to the AI performance service. This data includes data collected from augmentations such as check offs, playing instructions, applying signatures and the like. The data is associated with an individual worker who performed the procedure. The performance service predicts how activities across the procedure are related and creates a set of ‘steps” where the activities are focused in a specific task (e.g., remove oil filter). The engine then compares how each user performs these steps and identifies outlier steps that are not representative of actual performance and eliminates them from the performance score. The remaining data is then used to identify the proficiency of each worker for each procedure, comparing all users to one another. This enables targeted workforce development and training efforts. Additionally, the same service determines which procedures gave the most opportunity for productivity/time improvement presenting this to the users to focus operational improvement efforts.

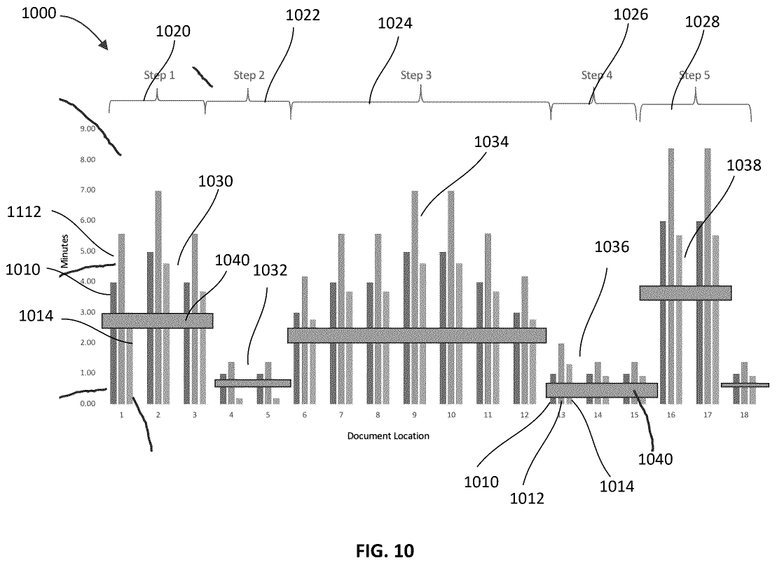

FIG. 10 shows a combined performance map 1000 generated from collected data from an augmented procedure file such as the file 302 in FIG. 3. The performance map 1000 plots the number of minutes for each worker to perform tasks of steps of a certain procedure. The performance map 1000 includes bars 1010, 1012, and 1014 that represent three different workers and the minutes that the respective worker used to perform a particular task. In this example, there are five step intervals 1020, 1022, 1024, 1026, and 1028. Each of the intervals 1020, 1022, 1024, 1026, and 1028 are broken down into specific tasks. Thus, bars 1010, 1012, 1014 are plotted for each specific task. A cluster 1030 includes the bars plots for the first step interval 1020. Corresponding clusters 1032, 1034, 1036 and 1038 each include the bar plots for the respective step intervals 1022, 1024, 1026, and 1028. A bar 1040 represents the AI-calculated benchmark for each logical step which is used in the True Productivity and True Proficiency calculations.

Each time the procedure is run, time and location events are streamed to an AI performance service of the client service application 304 in the Cloud from the respective worker device 102. A performance service of the client service application 304 predicts how activities across the procedure are related and creates a set of ‘steps” where the activities are focused in a specific task (e.g., remove oil filter). The performance service engine determines what parts of the procedure can be logically grouped into areas of “significant related activities” or steps after multiple executions of the same procedure. For example, the steps represented by the step intervals 1020, 1022, 1024, 1026, and 1028 and the specific tasks are created by the performance service engine of the cloud service application 304 from analysis of multiple execution of the same procedure. The performance service engine then compares how each user performs these steps and identifies outlier steps that are not representative of actual performance and eliminates them from the performance score. The remaining data is then used to identify the proficiency of each user for each step of the procedure, comparing all users to one another. This enables targeted workforce development and training efforts. Additionally, the same service determines which procedures gave the most opportunity for productivity/time improvement presenting this to the users to focus operational improvement efforts.

The generated performance may be used to optimize the current work procedure by use of a first predictive model and a second predictive model. The first model determines the productivity opportunity of each procedure and the second model determines the proficiency of each user for each procedure and an overall proficiency for all the procedures they execute. This process generates actionable insights for improving the work procedure based on the target instructions and the activity data. Actionable insights may include the addition of more augmentations that may decrease the performance time or other measures to improve performance. The AI performance engine of the Cloud service application 304 may also build a performance map for every user across all procedures and all executions. This performance map may be used to quantify performance of a worker. Further details of these processes may be found in U.S. Pat. No. 11,423,346.

The example AI “performance engine” uses techniques to automatically eliminate non- representative data “outliers” from the returned high granularity time data and then presents a time distribution view by progress labels. After multiple executions of the same procedure the performance engine determines what parts of the procedure can be logically grouped into areas of “Significant related activities” (steps) where these might be something like “replace pump filter” or “lockout and tagout machine.” The performance engine then presents a time distribution view by steps that may assist in productivity analysis.

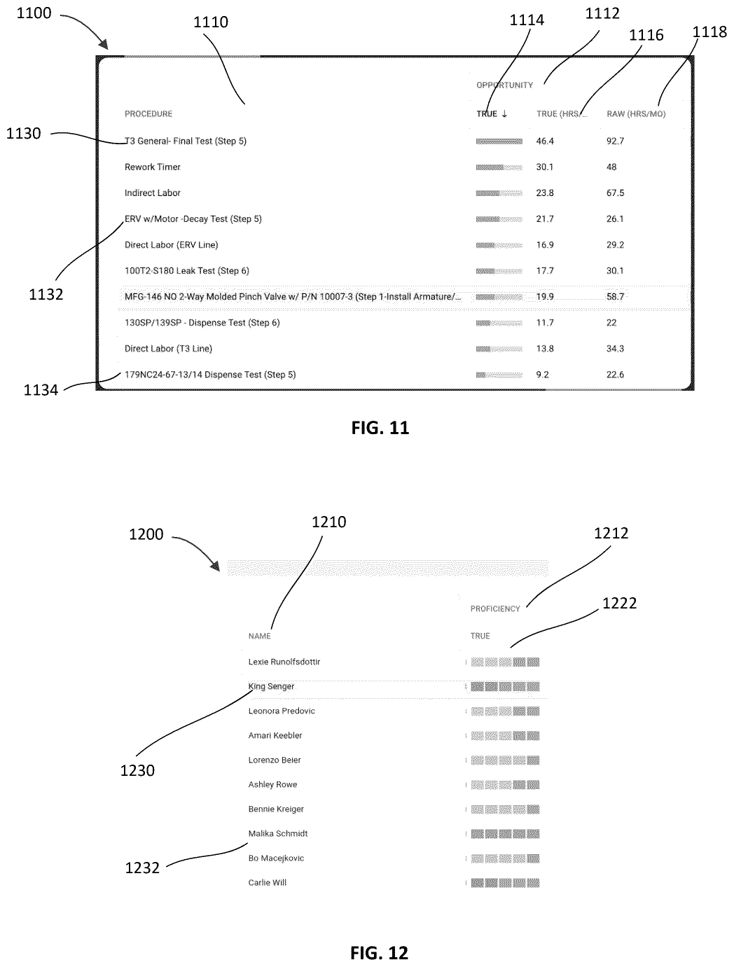

Additionally, the performance data would present the relative performance of each procedure versus all other procedures being monitored to determine which procedures offer the largest opportunity for performance improvement. FIG. 11 is an example interface 1100 that compares opportunity of potential time savings in procedures in comparison with all other procedures. One example of such a display interface is the interface generated by the True Productivity™ software available from Augmentir.

The interface 1100 includes a procedure column 1110 and an opportunity field 1112. The opportunity field 1112 has a column of true performance graphs 1114, a column of true hours 1116, and a raw hours column 1118. The procedure column 1110 includes a list of all procedures listed in order of ones with the most opportunity to the ones with the least opportunity. The true performance graphs 1114 shows a graphical representation of the relative true opportunity for each procedure. The true hours 1116 show the actual AI-calculated true opportunity hours on a monthly basis for each procedure. The raw hours 1118 show the actual raw opportunity hours on a monthly basis for each procedure. Thus, a first listed task 1130 shows a true hours of 46.4 hours per month in contrast with 92.7 raw hours per month. The listed task 1130 is identified as a task that may have the most potential improvement. Another task 1132 shows a true hours of 21.7 hours per month in contrast with 26.1 raw hours per month. The lowest rated task 1134 shows a true hours of 9.2 hours per month in contrast with 22.6 raw hours per month. The calculation to determine “True Opportunity” is determined by a series of AI-algorithms that process all the raw execution data and determine on a step level, what execution data is outside of a predicted representative time for that step (outlier). These algorithms adapt to the natural variability of each step/activity to accurately understand the natural variability of each step and to use this as part of the basis for determining what constitutes an outlier. The true data is then compared to the benchmark time for a step and an AI-determined percentage of the total amount of time greater than the benchmark represents the True opportunity normalized to hours/month. The calculation for raw opportunity uses all of the data from every execution and then follows the same calculation to determine the raw opportunity in hours/month.

The performance data may present the relative performance of each user versus the entire group of users for each procedure. The performance of each user may be used for purposes of training recommendations, determining compensation, determining job promotion and the like. FIG. 12 is an example interface 1200 that compare the proficiency of an individual user to all other users in an organization. One example of such a display interface is the interface generated by the True Performance™ software available from Augmentir.

The interface 1200 includes a worker name column 1210 and a proficiency column 1212. The worker name column 1210 includes a list of workers that have performed the procedure. A bar graph 1222 provides a graphical representation of each worker's overall proficiency versus all other workers in a group where one color such as dark green is the best and dark orange is the worst in this example. For example, a first worker 1230 has a corresponding 3 bars indicating average proficiency. The corresponding bars for the first worker 1230 may thus be shown in a first color such as orange to indicate average proficiency. A second worker 1232 has five bars indicating above average proficiency. The five bars may be shown in a second color such as green to highlight the above average proficiency. Proficiency indicates how long it take to perform a step in comparison other users and a benchmark time allowing companies to use this information to intelligently assign training, reskilling and upskilling activities. For example, if a company wanted to have this procedure executed the fastest they would assign their best worker to perform this procedure (e.g., worker 1232, “Malika Schmidt”) as she is the highest rated worker. If the company did not need the procedure performed quickly they could assign it to the worker 1230 (“King Senger”) so that he could increase his experience and become more proficient.

The system 100 thus provides high granularity timing data regarding what users are viewing in a procedure document displayed on user devices. As explained above, the data provides basic performance data in relation to an example procedure document. The system 100 may determine that users spent 11.2 minutes on step 1, 3 minutes on step 2, 21 minutes on step 3, and 1 minute on step 4. The system 100 may determine that on step 3 the mean was 21 minutes but the variability was from 10 minutes to 77 minutes. In such an example, the specific times for a user or users may be determined. For example, the system 100 may determine that user 11 and user 21 both spent 60-77 minutes each time they performed a procedure.

The AI performance engine may be used to eliminate noisy data and make these insights “True” (e.g., more representative of what actually happened). The insights may be based on changes during data collection as the procedure is performed multiple times. For example, users spent 11.2 raw mins and 7.2 True mins on step 1, 3 raw mins, 2.9 True mins on step 2, 21 raw mins 13 true min on step 3, 1 min raw true on step 4. On step 3 the raw mean was 21 minutes/15 True but the variability was from 10/7mins to 77/42 mins. User 11 and user 21 both spent 60-77 minutes each time they performed the procedure). The calculation to determine “True Opportunity” is determined by a series of AI-algorithms that process all the raw execution data and determines on a step level, what execution data is outside of a predicted representative time for that step (outlier). These algorithms adapt to the natural variability of each step/activity to accurately understand the natural variability of each step and to use this as part of the basis for determining what constitutes an outlier. The true data is then compared to the benchmark time for a step and an AI-determined percentage of the total amount of time greater than the benchmark represents the True opportunity normalized to hours/month. The calculation for raw opportunity uses all of the data from every execution and then follows the same calculation to determine the raw opportunity in hours/month.

The AI performance engine may then provide insights in relation to productivity improvements, user improvements, or improvements to the procedure. For example, the AI performance engine may determine that procedure 21 has 13 hours of true opportunity and 13.9 hours of raw opportunity, procedure 11 has 9 hours of true opportunity and 44 hours of raw opportunity; and procedure 7 has 8 hours of true opportunity and 21 hours of raw opportunity. The AI performance engine may then determine true productivity opportunities from the data from the procedures.

The AI performance engine may also determine true performance for a specific user. For example, user 11 may have an overall performance rating of 77 and user 21 may have an overall performance rating of 72. The calculation to determine “True Proficiency” is determined by a series of AI-algorithms that process all the raw execution data and determines on a step level, what execution data is outside of a predicted representative time for that step (outlier). These algorithms adapt to the natural variability of each step/activity to accurately understand the natural variability of each step and to use this as part of the basis for determining what constitutes an outlier. Using this “true data” each user is timed to perform a procedure compared to all other users performing the same procedures and an algorithm distributes users into 10 groups using a statistical distribution model whose shape reflects feedback from all users. Users may also be evaluated for recommendations on retraining. For example, based on the performance ratings on certain procedures, a retraining recommendation for user 15 may be made on changeover skill while a recommendation may be made for retraining user 10 on Lockout Tagout.

The AI performance engine may also recommend adding augmentations to the existing procedure document. For example, based on coordinate data and timing data, the Al performance engine may recommend adding media to page 3/location X-Y of a page of a procedure file to improve user understanding. As users move through the sequence of activities in a procedure the performance engine categorizes areas of the document into related activities (steps). For each step the performance engine finds those with the largest variability and then characterizes the cause of this variability to be either a training opportunity (actionable insight), where a small subset of the users have difficulty with the step, or a procedure content opportunity, where many users experience high variability with the step. In the former case, training as an actionable insight would be recommended for the subset of users. In the case of content, the step in the procedure is evaluated and it is seen to contain a great deal of text, at which point a recommendation is made to add a picture or video to this area.

Additional details for the above-mentioned principles may be disclosed in U.S. Pat. No. 11,423,346 and U.S. patent application Ser. No. 17/251,723, the contents of which are hereby incorporated by reference.

Each of these embodiments and obvious variations thereof is contemplated as falling within the spirit and scope of the claimed invention, which is set forth in the following claims.

1. A method for creating an interactive electronic document file comprising:
selecting a document having a description of a sequence of activities;
converting the document into an electronic file format that allows application of an augmentation;
selecting at least one augmentation for the sequence of activities; and
applying the selected augmentation to the converted document in the electronic file format.

2. The method of claim 1, wherein the augmentation is one of an addition to enhance the communication of the information in the converted document, a logical element to guide users to appropriate sections of the converted document, or a data collection element to enable digital data capture.

3. The method of claim 2, wherein the augmentation is one of the group of data entry; media display; attached documents; mixed or augmented reality experiences; troubleshooting elements; remote video assistance; remote audio assistance; step name with metadata; quizzes/tests; checklists; table entry; procedure metadata; picker interfaces; bar code or QR scanner; media capture; table displays; picker tables; signature entry; jump; loops to other sections; branches to other sections; escalation; index sections; embedded procedures; biometric; image recognition; and training content.

4. The method of claim 1, further comprising:
selecting a plurality of converted documents that have similar characteristics to the converted document; and
automatically selecting and applying the at least one augmentation to the plurality of converted documents.

5. The method of claim 1, further comprising displaying an authoring interface showing the converted document and a menu allowing selection of the at least one augmentation from a plurality of different augmentations.

6. The method of claim 1, further comprising sending the converted document with the augmentation to a user device.

7. The method of claim 6, further comprising applying a rule to determine whether the selected augmentation is activated on a display of the user device and wherein the augmentation accepts input data from a worker associated with the user device, and wherein the input data is sent to a cloud client application in communication with the user device.

8. (canceled)

9. A system comprising:
a memory; and
a controller including one or more processors, the controller operable to:
select a document having a description of a sequence of activities;
convert the document into an electronic file format that allows application of an augmentation;
select at least one augmentation for the sequence of activities; and
apply the selected augmentation to the converted document in the electronic file format.

10. The system of claim 9, wherein the augmentation is one of an addition to enhance the communication of the information in the converted document, a logical element to guide users to appropriate sections of the converted document, or a data collection element to enable digital data capture.

11. The system of claim 10, wherein the augmentation is one of the group of data entry; media display; attached documents; mixed or augmented reality experiences; troubleshooting elements; remote video assistance; remote audio assistance; step name with metadata; quizzes/tests; checklists; table entry; procedure metadata; picker interfaces; bar code or QR scanner; media capture; table Displays; picker tables; signature entry; jump; loops to other sections; branches to other sections; escalation; index sections; embedded procedures; biometric; image recognition; and training content.

12. The system of claim 9, wherein the controller is operable to display an authoring interface on an interface showing the procedure file and a menu allowing selection of the at least one augmentation from a plurality of different augmentations.

13. The system of claim 9, further comprising a network interface communicatively sending the converted document with the augmentation to a user device.

14. The system of claim 13, wherein the controller is operable to apply a rule to determine whether the selected augmentation is activated on a display of the user device.

15. The system of claim 14, wherein the augmentation accepts input data from a worker associated with the user device, and wherein the input data is sent to a cloud client application in communication with the user device.

16. A computer program product comprising instructions which, when executed by a computer, cause the computer to carry out:
selecting a document having a description of a sequence of activities;
converting the document into an electronic file format that allows application of an augmentation;
selecting at least one augmentation for the sequence of activities; and
applying the selected augmentation to the converted document in the electronic file format.

17. A method for collecting data for implementation of a sequence of activities performed by a user, the method comprising:
displaying the sequence of activities to the user via a user device;
accepting an input from the user device when an activity of the sequence of activities is completed;
correlating the time of the input with the completion of the activity; and
building a performance map from the sequence of activities and the times of completion for the user.

18. The method of claim 17, wherein the sequence of activities includes an augmentation allowing a user to input when the activity of the sequence is completed.

19. The method of claim 17, further comprising collecting an input of a visible screen coordinate associated with the time of the input from the user device.

20. The method of claim 19, wherein the user is one of a plurality of users, and wherein the performance map is built on collection of the completion of the sequence of activities and the times of completion for the plurality of users.

21. The method of claim 20, wherein the performance map shows the performance of the user relative to the performances of the plurality of users and wherein the sequence of activities is one of a plurality of sequence of activities, and wherein the performance map is built on collection of the completion of sequences of activities and the times of completion for the plurality of sequence of activities and wherein the performance map shows the performance of the sequence of activities relative to the performances of the plurality of sequences of activities.

22. (canceled)

23. (canceled)

24. A computer program product comprising instructions which, when executed by a computer, cause the computer to carry out:
displaying the sequence of activities to a user via user device;
accepting an input from the user when an activity of the sequence of activities is completed;
correlating the time of the input with the activity is completed; and
building a performance map from the sequence of activities and the times of completion for the user.
